(19) United States
(12) Patent Application Publication
(10) Pub. No.: US 2018/0081971 A1
(43) Pub. Date: Mar. 22, 2018

(54) SELECTING CONTENT FOR PRESENTATION TO AN ONLINE SYSTEM USER BASED IN PART ON DIFFERENCES IN CHARACTERISTICS OF THE USER AND OF OTHER ONLINE SYSTEM USERS

(71) Applicant: Facebook, Inc., Menlo Park, CA (US)

(72) Inventor: Andrew Donald Yates, San Francisco, CA (US)

(21) Appl. No.: 15/268,365

(22) Filed: Sep. 16, 2016

(51) Int. Cl. G06F 17/30; G06Q 30/02

(52) U.S. Cl. CPC G06F 17/30867; G06Q 30/0275; G06Q 30/0269

(57) ABSTRACT

An online system selects content for presentation to a user based on characteristics of the user, such as prior interactions with content by users having similar characteristics. To obtain information about interaction with a content item by users having a broader range of characteristics, the online system may increase an attribute of a content item used to select content based on a measure of dissimilarity between the user and other users who have previously been presented with the content item. The measure of dissimilarity may be determined based on differences between characteristics of the user and characteristics of users presented with the content item weighted by a temporal decay factor. For example, the online system increases an attribute of the content item by an amount directly related to the measure of dissimilarity and uses the increased attribute when determining whether to present the content item to the user.

### BACKGROUND

This invention relates generally to online systems, and more specifically to selecting content to online system users based on similarity of characteristics of different online system users.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

Many online systems select content for presentation to a user based on a predicted likelihood of the user interacting with the content in various ways. For example, an online system determines a likelihood of a viewing user interacting with a content item based on similarities between characteristics of the viewing user and other users who interacted with the content item. However, basing the likelihood of viewing users interacting with a content item based on similarities between characteristics of the viewing user and characteristics of other users who interacted with the content item may limit viewing users to whom the content item was presented. For example, viewing users having various characteristics differing from characteristics to whom a content item was presented may also be likely to interact with the content item, but are unlikely to be presented with the content item by conventional online system that determine a likelihood of the viewing user interacting with the content item based on similarities between characteristics of the viewing user and other users who were presented with the content item. Additionally, this limited presentation of the content item to viewing users with characteristics similar to users who were presented with the content item may prevent the online system from identifying alternative characteristics of users who interact with presented content items, reducing an accuracy with which the online system predicts likelihoods of different users interacting with content items.

### SUMMARY

An online system receives content items for presentation to one or more users of the online system. Some of the content items include targeting criteria specifying characteristics of users eligible to be presented with the content items. A content item including targeting criteria is eligible to be presented to users having characteristics satisfying at least a threshold number of the targeting criteria. Some content items may be associated with bid amounts, where a bid amount associated with a content item specifies an amount of compensation received by the online system from a user associated with the content item in exchange for presenting the content items to one or more users.

The online system also maintains one or more characteristics associated with each user of the online system. Characteristics of a user may include demographic information maintained in a user profile by the online system, actions performed by the user and identified to the online system, connections between the user and other users or objects, as well as any combination of demographic information, actions performed by the user, and connections between users or objects. Hence, characteristics of a user may be specified by the user to the online system, or the online system determines characteristics from actions of the user.

As the online system presents various content items to one or more users, a content item of the received content items is presented to various users. The online system stores information describing characteristics of presentation of the content item to various users. For example, the online system stores an identifier of the content item, a date and a time when the content item was presented to a user, and various characteristics describing presentation of the content item to the user. Example characteristics describing presentation of the content item to the user include: other content presented in addition to the content item, a device on which the content item was presented, a time of day when the content item was presented, an application executing on the client device used to present the content item, a third party system used to present the content item, or any other suitable information describing when or how the content item was presented. In some embodiments, the content item includes an identifier authorizing the online system to modify an attribute of the content item based on characteristics of users who have been presented with the content item. For example, the content item includes a value authorizing the online system to modify one or more attributes of the content items based on characteristics of users who have been presented with the content item. Information describing presentation of the content item to users is stored by the online system when the content item is presented to various users. For example, the online system stores an identifier of the content item in association with an identifier of a user to whom the content item was presented, and may also associate a date and a time when the content item was presented to the user in association with the identifier of the content item and the identifier of the user.

If the online system determines the content item is eligible for presentation to the viewing user (e.g., characteristics of the user satisfy at least a threshold amount of targeting criteria included in the content item), the online system retrieves characteristics associated with the viewing user by the online system and also retrieves characteristics associated with one or more users of the online system to whom the content item was presented. In some embodiments, the online system retrieves characteristics associated with users to whom the content item was presented in a particular time interval. Alternatively, the online system retrieves characteristics associated with users to whom the content item was presented within a threshold amount of time from a current time or from a time when the opportunity to present one or more content items to the viewing user was identified.

The online system may retrieve characteristics associated with users who were presented with content items having one or more attributes matching attributes of the content item. For example, the online system retrieves characteristics associated with users who were presented with one or more content items included in a campaign of content items that includes the content item. As another example, the online system retrieves characteristics associated with users who were presented with other content items including targeting criteria matching targeting criteria of the content item. The online system may retrieve characteristics associated with users who were presented with other content items having a type matching a type of the content item. In other embodiments, the online system retrieves characteristics associated with users having a location matching a location of the viewing user or associated with users having any suitable characteristic matching a characteristic of the viewing user. A publishing user providing the content item to the online system may identify characteristics associated with users or attributes of content items presented to users used by the online system to retrieve characteristics associated with other users in various embodiments.

From the retrieved characteristics associated with the viewing user by the online system and the retrieved characteristics associated with the one or more users to whom the content item was presented, the online system determines a measure of dissimilarity between the viewing user and the one or more users to whom the content item was presented. The measure of dissimilarity is based on differences between characteristics of the viewing user and characteristics of users who were presented with the content item. In one embodiment, the online system generates a vector for the viewing user based on characteristics associated with the viewing user by the online system. The vector has dimensions that are each based on characteristics associated with the viewing user. Similarly, the online system generates a vector for each of at least a set of the one or more users to whom the content item was presented, with a vector for a user to whom the content item was presented having dimensions based on characteristics associated with the viewing user by the online system. In some embodiments, the online system generates a vector for each user to whom the content item was presented. From the vectors generated for users to whom the content item was presented, the online system may determine a characteristic vector for the users to whom the content item was presented in some embodiments. The online system determines the measure of dissimilarity between the viewing user and the users to whom the content item was presented based on a distance between the vector generated for the viewing user and the characteristic vector. In some embodiments, the measure of dissimilarity is the distance between the vector generated for the viewing user and the characteristic vector.

Alternatively, the measure of dissimilarity is the distances between the vector generated for the viewing user and the characteristic vector weighted by a temporal decay factor based on a difference between the time when the online system identified the opportunity to present one or more content items and an average time when users to whom the content item was presented were presented with the content item. In various embodiments, the temporal decay factor is an exponential decay factor inversely related to the difference between the time when the online system identified the opportunity to present one or more content items and an average time when users to whom the content item was presented were presented with the content item. Hence, the temporal decay factor reduces the measure of dissimilarity between the viewing user and users to whom the content item was more recently presented.

In some embodiments, the online system determines characteristic vectors for users to whom the content item was presented at different times and determines distances between the vector generated for the viewing user and characteristic vectors for users to whom the content item was presented at different times. The online system may weight each distance by a temporal decay factor based on a difference between times when the content item was presented to users and the time when the online system identified the opportunity to present one or more content items to the viewing user. To determine the measure of dissimilarity, the online system selects a set of the distances between the vector generated for the viewing user and characteristic vectors for users to whom the content item was presented at different times weighted by the corresponding times when the content item was presented to different users and averages the selected set of the distances. For example, the online system ranks the distances between the vector generated for the viewing user and characteristic vectors for users to whom the content item was presented at different times weighted by temporal decay factors corresponding times when the content item was presented to different users and selects the set as distances weighted by their corresponding temporal decay factors having at least a threshold position in the ranking. Alternatively, the online system selects the set as distances weighted by their corresponding temporal decay factors having at least having at least a threshold value. The online system may vary the number of distances weighted by their corresponding temporal decay factors selected for the set based on different criteria in some embodiments.

In various embodiments, the online system identifies a subset of the retrieved characteristics associated with users to whom the content item was presented (or associated with users having characteristics matching characteristics of the viewing user or associated with users to whom content items having attributes matching attributes of the content item were presented) and determines the measure of dissimilarity based on differences between characteristics in the subset of the viewing user and of the users to whom the content item was presented. For example, the online system generates clusters of characteristics associated with users to whom the content item was presented (or associated with users having characteristics matching characteristics of the viewing user or associated with users to whom content items having attributes matching attributes of the content item were presented) using one or more clustering methods. For example, the online system identifies clusters of characteristics of users through a k-means clustering algorithm using Euclidean distance mean or cosine distance between characteristics of users. As another example, the online system identifies a subset of characteristics based on classification of characteristics of users by one or more non-linear classification methods. For example, the online system applies a gradient boosted decision tree (GBDT) method to characteristics of users. Application of the one or more non-linear classification methods to characteristics of users to whom the content item was presented generates clusters of characteristics associated with users to whom the content item was presented. The online system identifies a subset of characteristics associated with users to whom the content item was presented (or associated with users having characteristics matching characteristics of the viewing user or to whom content items having attributes matching attributes of the content item were presented) as a cluster of characteristics that is more frequently associated with users to whom the content item was presented (or associated with users having characteristics matching characteristics of the viewing user or to whom content items having attributes matching attributes of the content item were presented) than with general users of the online system.

In various embodiments, the online system also accounts for characteristics of prior presentations of the content item to users and characteristics of an opportunity to present the content item to the viewing user for which the online system determined the content item was eligible for presentation to the viewing user. The online system may retrieve characteristics describing presentations of the content item to other users during a particular time interval. Alternatively, the online system retrieves characteristics describing presentation of the content item to users within a threshold amount of time from a current time or from a time when the opportunity to present one or more content items to the viewing user was identified.

The online system may retrieve characteristics associated with presentation of content items having one or more attributes matching attributes of the content item to various users. For example, the online system retrieves characteristics associated with presentation of content items to users who were presented with one or more content items included in a campaign of content items that includes the content item. As another example, the online system retrieves characteristics describing presentation of content items including targeting criteria matching targeting criteria of the content item to various users. The online system may retrieve characteristics associated with presentation of content items having a type matching a type of the content item to various users. In other embodiments, the online system retrieves characteristics describing presentation of content items having any suitable characteristic matching a characteristic of the opportunity to present the content item to the viewing user to other users. A publishing user providing the content item to the online system may identify characteristics associated with users or characteristics of presentation of content items to users of the online system to retrieve characteristics associated with other users or associated with other presentations of content items in various embodiments.

From the retrieved characteristics associated with the opportunity to present the content item to the viewing user and associated with other presentations of the content item, or other content items, to other users, the online system determines the measure of dissimilarity between the opportunity to present the content item to the viewing user and prior presentation of the content item, or other content items, to one or more other users. In some embodiments, the measure of dissimilarity is based on differences between characteristics of the opportunity to present the content item to the viewing user and characteristics of prior presentation of other content items, or of the content item, to other users; the measure of dissimilarity may be based on differences between characteristics of the opportunity to present the content item to the viewing user and characteristics of prior presentation of other content items, or of the content item, to other users as well as differences between characteristics of the viewing user and characteristics of users who were presented with the content item in other embodiments. For example, the online system generates a vector for the opportunity to present the content item to the viewing user. The vector has dimensions that are each based on characteristics associated with the opportunity to present the content item to the viewing user. Similarly, the online system generates a vector for each prior presentation of the content item, or of another content item, to another user to whom the content item was presented, with a vector for a prior presentation of the content item, or of another content item, having dimensions based on characteristics associated with the prior presentation of the content item, or of the other content item, by the online system. In some embodiments, the online system generates a vector for each user to whom the content item was presented. From the vectors generated for prior presentation of the content item, or of another content item, to users of the online system, the online system may determine a characteristic vector for the prior presentations of the content item, or of the other content items, in some embodiments. The online system determines the measure of dissimilarity between the opportunity to present the content item to the viewing user and the prior presentations of the content item, or of other content items, to other users based on a distance between the vector generated for the opportunity to present the content item to the viewing user and the characteristic vector. In some embodiments, the measure of dissimilarity is the distance between the vector generated for the opportunity to present the content item to the viewing user and the characteristic vector. Alternatively, the measure of dissimilarity is the distance between the vector generated for the opportunity to present the content item to the viewing user and the characteristic vector weighted by a temporal decay factor based on a difference between the time when the online system identified the opportunity to present one or more content items to the viewing user and an average time when the content item, or when the other content items, were presented to other users. As further described above, the temporal decay factor is an exponential decay factor inversely related to the difference between the time when the online system identified the opportunity to present one or more content items to the viewing user and an average time when the content item, or another content item, was presented to other users. Hence, the temporal decay factor reduces the measure of dissimilarity between the opportunity to present the content item to the viewing user and more recent presentation of the content item, or of other content items.

In some embodiments, the online system determines characteristic vectors for presentation of the content item, or of other content items, at different times and determines distances between the vector generated for the opportunity to present the content item to the viewing user and characteristic vectors for prior presentation of the content item to various users at different times. The online system may weight each distance by a temporal decay factor based on a difference between times when the content item was presented to users and the time when the online system identified the opportunity to present one or more content items to the viewing user. To determine the measure of dissimilarity, the online system selects a set of the distances between the vector generated for the opportunity to present the content item to the viewing user and characteristic vectors for prior presentations of the content item to other users at different times weighted by the corresponding times when the content item was presented to different users and averages the selected set of the distances. For example, the online system ranks the distances between the vector generated for the opportunity to present the content item to the viewing user and characteristic vectors for prior presentation of the content item to other users at different times weighted by temporal decay factors corresponding times when the content item was presented to different users and selects the set as distances weighted by their corresponding temporal decay factors having at least a threshold position in the ranking. Alternatively, the online system selects the set as distances weighted by their corresponding temporal decay factors having at least having at least a threshold value. The online system may vary the number of distances weighted by their corresponding temporal decay factors selected for the set based on different criteria in some embodiments.

In various embodiments, the online system identifies a subset of the retrieved characteristics associated with prior presentation of the content item, or of other content items, to other users and determines the measure of dissimilarity based on differences between characteristics in the subset of and characteristics of the opportunity to present the content item to the viewing user. For example, the online system generates clusters of characteristics associated with prior presentations of the content item, or of other content items, to users of the online system using one or more clustering methods. For example, the online system identifies clusters of characteristics of users through a k-means clustering algorithm using Euclidean distance mean or cosine distance between characteristics of presentations of the content item or of other content items. As another example, the online system identifies a subset of characteristics based on classification of characteristics of presentation of the content item or of other content items to users by one or more non-linear classification methods. For example, the online system applies a gradient boosted decision tree (GBDT) method to characteristics of prior presentation of the content item or of other content items to users. Application of the one or more non-linear classification methods to characteristics of presentation of the content item or of other content items generates clusters of characteristics associated with prior presentation of the content item or of other content items. The online system identifies a subset of characteristics associated with prior presentation of the content item or of other content items as a cluster of characteristics that is more frequently associated with prior presentations of the content item or of other content items to other users. Hence, the online system may determine the measure of dissimilarity based on characteristics of users, characteristics of presentation of the content item or of other content items, or a combination of characteristics of users and characteristics of presentation of the content item.

Based on the determined measure of dissimilarity, the online system modifies one or more attributes of the content item and determines whether to present the content item to the viewing user based on the modified one or more attributes and one or more models determining likelihoods of the viewing user performing various interactions when presented with the content item. In various embodiments, the content item includes a bid amount specifying an amount of compensation a publishing user providing the content item to the online system will provide the online system in exchange for presentation of the content item to users or in exchange for one or more interactions with the content item by users. The online system modifies the bid amount included in the content item based on the determined measure of dissimilarity. For example, the online system increases the bid amount by an amount based on the determined measure of dissimilarity. The online system may add the amount based on the determined measure of dissimilarity to the bid amount included in the content item.

The online system includes the content item in association with the modified attribute and the one or more models determining likelihoods of the viewing user performing one or more interactions after being presented with the content item in one or more selection processes that include additional content items eligible for presentation to the viewing user. Content items selected by the one or more selection processes are provided by the online system to a client device for presentation to the viewing user. A selection process may rank the content item and the additional content items based on bid amounts included in the content item and in the additional content item and select content items having at least a threshold position in the ranking for presentation to the viewing user. As another example, a selection process selects content items from the content item and the additional content items having at least a threshold bid amount for presentation to the viewing user.

By modifying an attribute of the content item based on the measure of dissimilarity between the viewing user and other users to whom the content item was presented, the online system presents the content item to users having a broader range of characteristics. This allows the publishing user who provided the content item to the online system to evaluate how users having a broader range of characteristics interact with the content item, which may allow the publishing user to provide more relevant content to more users. Providing the content item to users having a broader range of characteristics increases an amount of data that the online system may user to train a model determining likelihoods of various users interacting with the content item. Obtaining information describing interaction with the content item by users having more varied characteristics allows the model to account for more varied characteristics of users when determining a likelihood of a user interacting with the content item.

In response to determining to present the content item to the viewing user, the online system provides the content item to a client device associated with the viewing user for presentation to the viewing user. When the client device presents the content item to the viewing user, the online system receives information from the client device indicating whether the user performed one or more interactions after being presented with the content item. For example, an application associated with the online system and executing on the client device transmits information to the online system identifying one or more interactions with the content item by the viewing user or identifying one or more actions performed by the viewing user after presentation of the content item. Based on the received information and the characteristics of the viewing user, the online system modifies one or more models determining the likelihood of the viewing user performing one or more interactions after being presented with the content item. For example, if the received information indicates the viewing user performed an interaction with the content item, the online system modifies a model determining a likelihood of users performing the interaction with the content item so the model determines a higher likelihood of users having one or more characteristics of the viewing user performing the action. Similarly, if the received information indicates the viewing user did not perform the interaction with the content item or if the online system does not receive information indicating the user performed the interaction with the content item at least a threshold amount of time after the content item was presented to the viewing user, the online system modifies the model determining a likelihood of users performing the interaction with the content item so the model determines a lower likelihood of users having one or more characteristics of the viewing user performing the action. In various embodiments, the online system determines a rate of change of a model that is modified based on interactions by viewing users presented with content items based at least in part on measures of dissimilarity between the viewing users and other users previously presented with the content item and ceases determining whether to present the content item to viewing users based on the measures of dissimilarity if a rate of change of the model does not exceed a threshold rate of change.

In some embodiments, the online system modifies determination of the measure of dissimilarity between the viewing user and the one or more users to whom the content item was presented (or one or more users identified as further described above) over time to increase a likelihood that modifying the attribute of the content item based on the determined measure of dissimilarity causes the online system to present the content item to viewing users having different characteristics than characteristics of the one or more users to whom the content item was presented. For example, the online system retrieves information describing previously completed selection processes for one or more other content items, modifies the attribute of the one or more content items included in a previously completed selection process, and compares the modified attribute of the one or more content items to values of the attributes for additional content items in the previously completed selection processes. Comparison of the modified attributes to attributes in the previously completed selection processes allows evaluation of the effectiveness of the modified attributes in selection of the one or more content items by selection processes by identifying previously completed selection processes in which the modified attributes would have caused selection of the one or more content items. In various embodiments, the online system provides the publishing users with information describing modification of the attribute of the content item on presentation of the content item by the online system.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for selecting content items for presentation to a user based on dissimilarity between characteristics of the user and other users of the online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

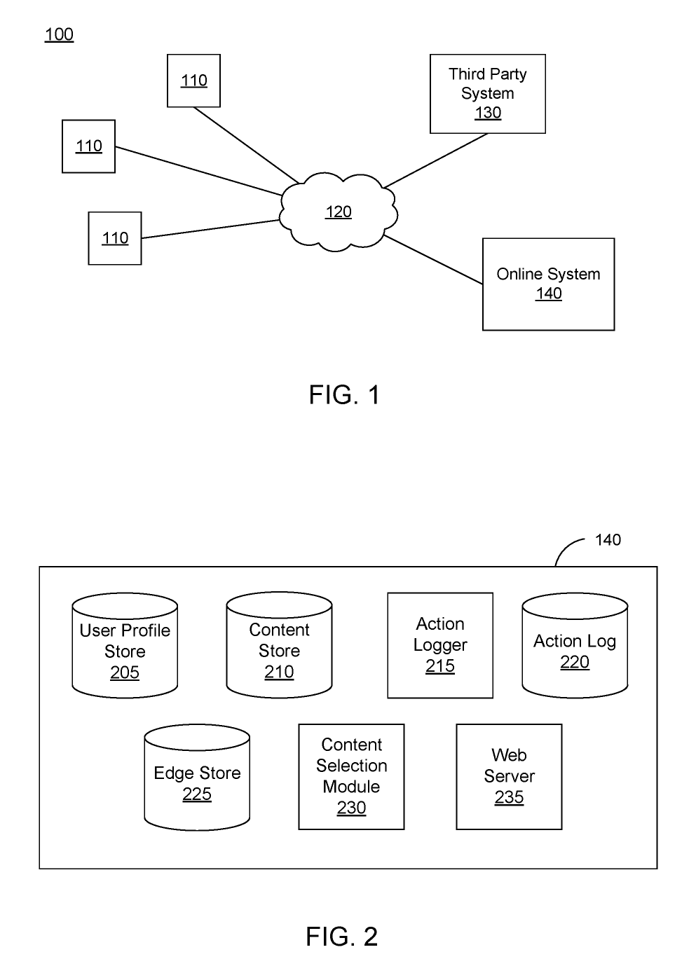

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein can be adapted to online systems that are social networking systems, content sharing networks, or other systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

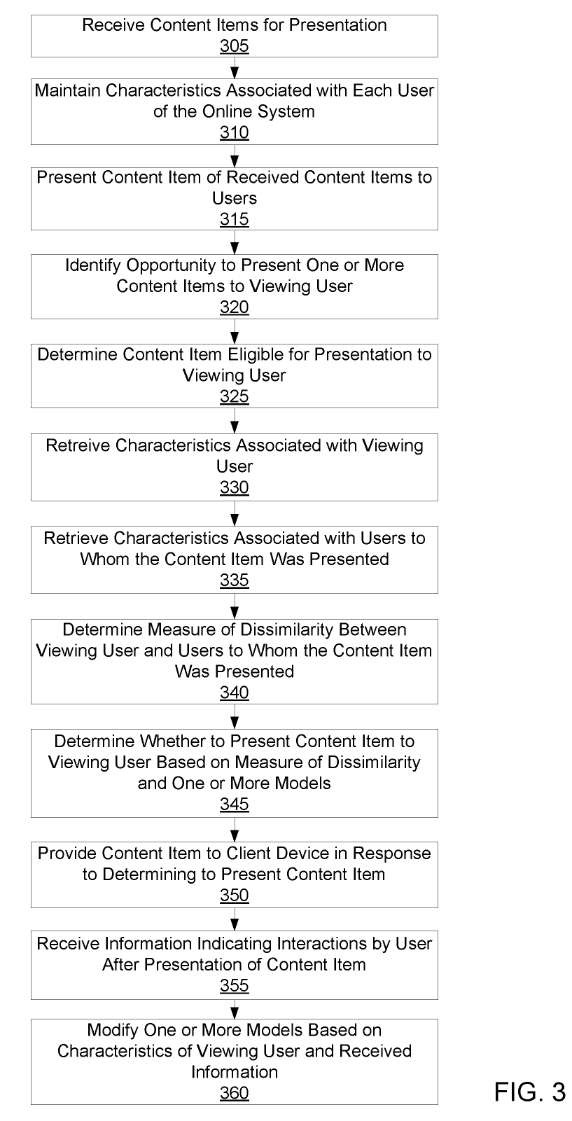

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130. In some embodiments, one or more of the third party systems 130 provide content to the online system 140 for presentation to users of the online system 140 and provide compensation to the online system 140 in exchange for presenting the content. For example, a third party system 130 provides content items associated with amounts of compensation provided by the third party system 130 to the online system 140 in exchange presenting the content items to users of the online system 140.

FIG. 2 is a block diagram of architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also includes a landing page specifying a network address to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with content items on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, content items that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based one or more models determining likelihoods of the user performing various interactions when presented with the content item. For example, the content selection module 230 determines measures of relevance of various content items to the user by applying one or more models determining likelihoods of the user performing various interactions when presented with the content item and selects content items for presentation to the user based on the measures of relevance. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item determined by applying one or more models to characteristics of the user. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

In various embodiments, when determining whether to present a content item to a viewing user, the content selection module 230 determines a measure of dissimilarity between the viewing user and other users that is based on differences between characteristics of the viewing user and characteristics of the other users. For example, the content selection module 230 determines a measure of dissimilarity between the viewing users and other users to whom the content item was presented, between the viewing user and other users to whom one or more content items included in a campaign that also includes the content item was presented, or between the viewing user and other users to whom one or more content items having a type matching a type of the content item were presented. Determination of the measure of dissimilarity between the viewing user and other users is further described below in conjunction with FIG. 3.

Based on the determined measure of dissimilarity, the content selection module 230 determines whether to present the content item to the user. In some embodiments, the content selection module 230 increases a measure of relevance based on determined measure of dissimilarity and includes the content selection module 230 in one or more selection processes selecting content for presentation to the user. In other embodiments, the content selection module 230 modifies one or more suitable attributes of the content item and includes the content item in one or more selection processes in association with the modified one or more attributes. For example, if the content item includes a bid amount, the content selection module 230 increases the bid amount by a value based on the measure of dissimilarity. Based on the increased bid amount included in the content item and bid amounts included in additional content items, one or more selection processes performed by the content selection module 230 select content for presentation to the viewing user. Modification of an attribute of the content item based on the measure of dissimilarity is further described below in conjunction with FIG. 3.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

### Selecting Content for Online System Users Based on Dissimilarity Between the Users

FIG. 3 is a flowchart of one embodiment of a method for selecting content items for presentation to a user based on dissimilarity between characteristics of the user and other users of the online system. In other embodiments, the method may include different and/or additional steps than those shown in FIG. 3. Additionally, steps of the method may be performed in different orders than the order described in conjunction with FIG. 3 in various embodiments.

An online system 140 receives 305 content items for presentation to one or more users of the online system 140. Some of the content items include targeting criteria specifying characteristics of users eligible to be presented with the content items. As described above in conjunction with FIG. 2, a content item including targeting criteria is eligible to be presented to users having characteristics satisfying at least a threshold number of the targeting criteria. Additionally, some content items may be associated with bid amounts, where a bid amount associated with a content item specifies an amount of compensation received by the online system 140 from a user associated with the content item in exchange for presenting the content items to one or more users.

Additionally, as further described above in conjunction with FIG. 2, the online system 140 maintains 310 one or more characteristics associated with each user of the online system 140. Characteristics of a user may include demographic information maintained in a user profile by the online system 140, actions performed by the user and identified to the online system 140, connections between the user and other users or objects, as well as any combination of demographic information, actions performed by the user, and connections between users or objects. Hence, characteristics of a user may be specified by the user to the online system 140, or the online system 140 determines characteristics from actions of the user.

As the online system 140 presents content to its users, the online system 140 presents 315 a content item of the received content items to one or more users. The online system 140 stores information describing characteristics of presentation of the content item to various users. For example, the online system 140 stores an identifier of the content item, a date and a time when the content item was presented to a user, and various characteristics describing presentation of the content item to the user. Example characteristics describing presentation of the content item to the user include: other content presented in addition to the content item, a client device 110 on which the content item was presented, a time of day when the content item was presented, an application executing on the client device 110 used to present the content item, a third party system 130 used to the content item, or any other suitable information describing when or how the content item was presented. In some embodiments, the content item includes an identifier authorizing the online system 140 to modify an attribute of the content item based on characteristics of users who have been presented with the content item. For example, the content item includes a value for a field or a flag authorizing the online system 140 to modify one or more attributes of the content items based on characteristics of users who have been presented with the content item. As another example, a publishing user who provides content items to the online system 140 for presentation provides the online system 140 with a listing of identifiers of content items for which the online system 140 is authorized to modify one or more attributes of the content items based on characteristics of users who were presented with the content items. For example, the content item presented 315 by the online system 140 has an identifier included in a list of identifiers of content items for which the online system is authorized by a publishing user providing the content items to modify one or more attributes based on characteristics of users who were presented with the content items.

When the online system 140 presents 315 the content item to users, the online system 140 stores information describing presentation of the content item to different users. In various embodiments, the online system 140 stores an identifier of the content item in association with an identifier of a user to whom the content item was presented, and may also associate a date and a time when the content item was presented to the user in association with the identifier of the content item and the identifier of the user. In some embodiments, the online system 140 stores a connection between information identifying the user and information identifying the content item when the content item is presented to the user; the connection may include a date and a time when the content item was presented to the user.

When the online system 140 identifies 320 an opportunity to present one or more content items to a viewing user, the online system 140 determines 325 whether the content item is eligible for presentation to the viewing user. If the content item includes targeting criteria, the online system 140 compares characteristics of the viewing user maintained by the online system 140 to the targeting criteria and determines 325 the content item is eligible for presentation to the viewing user if the characteristics of the viewing user satisfy at least a threshold number of the targeting criteria. However, if the characteristics of the viewing user to not satisfy at least the threshold number of targeting criteria included in content item, the online system 140 determines 325 the content item is not eligible for presentation to the user. Alternatively, if the content item does not include targeting criteria, the online system 140 determines 325 the content item is eligible for presentation to the viewing user.

If the online system 140 determines 325 the content item is eligible for presentation to the viewing user, the online system 140 retrieves 330 characteristics associated with the viewing user by the online system 140 and retrieves 335 characteristics associated with one or more users of the online system 140 to whom the content item was presented 315. In some embodiments, the online system 140 retrieves 335 characteristics associated with users to whom the content item was presented 315 in a particular time interval. Alternatively, the online system 140 retrieves 335 characteristics associated with users to whom the content item was presented 315 within a threshold amount of time from a current time or from a time when the opportunity to present one or more content items to the viewing user was identified 320. For example, the online system 140 retrieves 335 characteristics associated with users who were presented 315 with the content item within a month prior to the online system 140 identifying 320 the opportunity to present one or more content items to the viewing user.

In various embodiments, the online system 140 retrieves 335 characteristics associated with users who were presented with content items having one or more attributes matching attributes of the content item. For example, the online system 140 retrieves 335 characteristics associated with users who were presented with one or more content items included in a campaign of content items that includes the content item. As another example, the online system 140 retrieves 335 characteristics associated with users who were presented with other content items including targeting criteria matching targeting criteria of the content item. The online system 140 may retrieve 335 characteristics associated with users who were presented with other content items having a type matching a type of the content item. In other embodiments, the online system 140 retrieves 335 characteristics associated with users having a location matching a location of the viewing user or associated with users having any suitable characteristic matching a characteristic of the viewing user. A publishing user providing the content item to the online system 140 may identify characteristics associated with users or attributes of content items presented to users used by the online system 140 to retrieve 335 characteristics associated with other users in various embodiments.

From the retrieved 330 characteristics associated with the viewing user by the online system 140 and the retrieved 335 characteristics associated with the one or more users to whom the content item was presented, the online system 140 determines 340 a measure of dissimilarity between the viewing user and the one or more users to whom the content item was presented. The online system 140 determines 340 the measure of dissimilarity based on differences between characteristics of the viewing user and characteristics of users who were presented with the content item. Various methods may be used by the online system 140 to determine 340 the measure of dissimilarity.

In one embodiment, the online system 140 generates a vector for the viewing user based on characteristics associated with the viewing user by the online system 140. The vector has dimensions that are each based on characteristics associated with the viewing user. Similarly, the online system 140 generates a vector for each of at least a set of the one or more users to whom the content item was presented, with a vector for a user to whom the content item was presented having dimensions based on characteristics associated with the viewing user by the online system 140. In some embodiments, the online system 140 generates a vector for each user to whom the content item was presented. From the vectors generated for users to whom the content item was presented, the online system 140 determines a characteristic vector for the generated vectors, such as a centroid of the generated vectors, in some embodiments. The online system 140 determines 340 the measure of dissimilarity between the viewing user and the users to whom the content item was presented based on a distance between the vector generated for the viewing user and the characteristic vector. In some embodiments, the measure of dissimilarity is the distance between the vector generated for the viewing user and the characteristic vector. Alternatively, the measure of dissimilarity is the distances between the vector generated for the viewing user and the characteristic vector weighted by a temporal decay factor based on a difference between the time when the online system 140 identified 320 the opportunity to present one or more content items and an average time when users to whom the content item was presented were presented with the content item. In various embodiments, the temporal decay factor is an exponential decay factor inversely related to the difference between the time when the online system 140 identified 320 the opportunity to present one or more content items and an average time when users to whom the content item was presented were presented with the content item. Hence, the temporal decay factor reduces the measure of dissimilarity between the viewing user and users to whom the content item was more recently presented.

In some embodiments, the online system 140 determines characteristic vectors for various sets of users to whom the content item was presented at different times and determines distances between the vector generated for the viewing user and characteristic vectors for various sets including users to whom the content item was presented at different times. The online system 140 may weight each distance by a temporal decay factor, as described above, based on a difference between times when the content item was presented to users and the time when the online system 140 identified 320 the opportunity to present one or more content items to the viewing user. To determine 340 the measure of dissimilarity, the online system 140 selects a set of the distances between the vector generated for the viewing user and characteristic vectors for users to whom the content item was presented at different times weighted by the corresponding times when the content item was presented to different users and averages the selected set of the distances. For example, the online system 140 ranks the distances between the vector generated for the viewing user and characteristic vectors for users to whom the content item was presented at different times weighted by temporal decay factors corresponding times when the content item was presented to different users and selects the set as distances weighted by their corresponding temporal decay factors having at least a threshold position in the ranking. Alternatively, the online system 140 selects the set as distances weighted by their corresponding temporal decay factors having at least having at least a threshold value. The online system 140 may vary the number of distances weighted by their corresponding temporal decay factors selected for the set based on different criteria in some embodiments.

In various embodiments, the online system 140 identifies a subset of the retrieved characteristics associated with users to whom the content item was presented (or associated with users having characteristics matching characteristics of the viewing user or associated with users to whom content items having attributes matching attributes of the content item were presented) and determines 340 the measure of dissimilarity based on differences between characteristics in the subset of the viewing user and of the users to whom the content item was presented. For example, the online system 140 generates clusters of characteristics associated with users to whom the content item was presented (or associated with users having characteristics matching characteristics of the viewing user or associated with users to whom content items having attributes matching attributes of the content item were presented) using one or more clustering methods. For example, the online system 140 identifies clusters of characteristics of users through a k-means clustering algorithm using Euclidean distance mean or cosine distance between characteristics of users. The online system 140 identifies a subset of characteristics associated with users to whom the content item was presented (or associated with users having characteristics matching characteristics of the viewing user or to whom content items having attributes matching attributes of the content item were presented) as a cluster of characteristics that is more frequently associated with users to whom the content item was presented (or associated with users having characteristics matching characteristics of the viewing user or to whom content items having attributes matching attributes of the content item were presented) than with general users of the online system 140.

As another example, the online system 140, identifies a subset of characteristics based on classification of characteristics of users by one or more non-linear classification methods. For example, the online system 140 applies a gradient boosted decision tree (GBDT) method to characteristics of users. Application of the one or more non-linear classification methods to characteristics of users to whom the content item was presented generates clusters of characteristics associated with users to whom the content item was presented. The online system 140 identifies a subset of characteristics associated with users to whom the content item was presented (or associated with users having characteristics matching characteristics of the viewing user or to whom content items having attributes matching attributes of the content item were presented) as a cluster of characteristics that is more frequently associated with users to whom the content item was presented (or associated with users having characteristics matching characteristics of the viewing user or to whom content items having attributes matching attributes of the content item were presented) than with general users of the online system 140. The online system 140 may use other suitable methods, such as matrix factorization or principal component analysis to identify a subset of the characteristics used to determine 340 the measure of dissimilarity.

Alternatively, based on prior interactions by users presented with content by the online system 140, the online system 140 determines a subset of characteristics of users indicating a likelihood of users interacting with content and determines differences between the viewing user's characteristics included in the subset and characteristics included in the subset of other users to whom the content item was presented to determine 340 the measure of dissimilarity. Additionally, the online system 140 may also identify correlations between characteristics of users. When characteristics are correlated with each other, the online system 140 selects a single of the correlated characteristics to use when determining 340 the measure of dissimilarity between the viewing user and other users to whom the content item was presented.

In various embodiments, the online system 140 also (or alternatively) accounts for characteristics of prior presentations of the content item to users and characteristics of an opportunity to present the content item to the viewing user for which the online system 140 determined 325 the content item was eligible for presentation to the viewing user. The online system 140 may retrieve characteristics describing presentations of the content item to other users during a particular time interval. Alternatively, the online system 140 retrieves characteristics describing presentation of the content item to users within a threshold amount of time from a current time or from a time when the opportunity to present one or more content items to the viewing user was identified.

The online system 140 may retrieve characteristics associated with presentation of content items having one or more attributes matching attributes of the content item to various users. For example, the online system 140 retrieves characteristics associated with presentation of content items to users who were presented with one or more content items included in a campaign of content items that includes the content item. As another example, the online system 140 retrieves characteristics describing presentation of content items including targeting criteria matching targeting criteria of the content item to various users. The online system 140 may retrieve characteristics associated with presentation of content items having a type matching a type of the content item to various users. In other embodiments, the online system 140 retrieves characteristics describing presentation of content items having any suitable characteristic matching a characteristic of the opportunity to present the content item to the viewing user to other users. A publishing user providing the content item to the online system 140 may identify characteristics associated with users or characteristics of presentation of content items to users of the online system 140 to retrieve characteristics associated with other users or associated with other presentations of content items in various embodiments.

From the retrieved characteristics associated with the opportunity to present the content item to the viewing user and associated with other presentations of the content item, or other content items, to other users, the online system 140 determines 340 the measure of dissimilarity between the opportunity to present the content item to the viewing user and prior presentation of the content item, or other content items, to one or more other users. In some embodiments, the measure of dissimilarity is based on differences between characteristics of the opportunity to present the content item to the viewing user and characteristics of prior presentation of other content items, or of the content item, to other users; the measure of dissimilarity may be based on differences between characteristics of the opportunity to present the content item to the viewing user and characteristics of prior presentation of other content items, or of the content item, to other users as well as differences between characteristics of the viewing user and characteristics of users who were presented with the content item in other embodiments. For example, the online system 140 generates a vector for the opportunity to present the content item to the viewing user. The vector has dimensions that are each based on characteristics associated with the opportunity to present the content item to the viewing user. Similarly, the online system 140 generates a vector for each prior presentation of the content item, or of another content item, to another user to whom the content item was presented, with a vector for a prior presentation of the content item, or of another content item, having dimensions based on characteristics associated with the prior presentation of the content item, or of the other content item, by the online system. In some embodiments, the online system 140 generates a vector for each user to whom the content item was presented 315. From the vectors generated for prior presentation of the content item, or of another content item, to users of the online system 140, the online system 140 may determine a characteristic vector for the prior presentations of the content item, or of the other content items, in some embodiments. The online system 140 determines 340 the measure of dissimilarity between the opportunity to present the content item to the viewing user and the prior presentations of the content item, or of other content items, to other users based on a distance between the vector generated for the opportunity to present the content item to the viewing user and the characteristic vector. In some embodiments, the measure of dissimilarity is the distance between the vector generated for the opportunity to present the content item to the viewing user and the characteristic vector. Alternatively, the measure of dissimilarity is the distance between the vector generated for the opportunity to present the content item to the viewing user and the characteristic vector weighted by a temporal decay factor based on a difference between the time when the online system 140 identified the opportunity to present one or more content items to the viewing user and an average time when the content item, or when the other content items, were presented 315 to other users. As further described above, the temporal decay factor is an exponential decay factor inversely related to the difference between the time when the online system 140 identified the opportunity to present one or more content items to the viewing user and an average time when the content item, or another content item, was presented 315 to other users. Hence, the temporal decay factor reduces the measure of dissimilarity between the opportunity to present the content item to the viewing user and more recent presentation of the content item, or of other content items.

In some embodiments, the online system 140 determines characteristic vectors for presentation of the content item, or of other content items, at different times and determines distances between the vector generated for the opportunity to present the content item to the viewing user and characteristic vectors for prior presentation of the content item to various users at different times. The online system 140 may weight each distance by a temporal decay factor based on a difference between times when the content item was presented 315 to users and the time when the online system 140 identified the opportunity to present one or more content items to the viewing user. To determine 340 the measure of dissimilarity, the online system 140 selects a set of the distances between the vector generated for the opportunity to present the content item to the viewing user and characteristic vectors for prior presentations of the content item to other users at different times weighted by the corresponding times when the content item was presented 315 to different users and averages the selected set of the distances. For example, the online system 140 ranks the distances between the vector generated for the opportunity to present the content item to the viewing user and characteristic vectors for prior presentation of the content item to other users at different times weighted by temporal decay factors corresponding times when the content item was presented 315 to different users and selects the set as distances weighted by their corresponding temporal decay factors having at least a threshold position in the ranking. Alternatively, the online system 140 selects the set as distances weighted by their corresponding temporal decay factors having at least having at least a threshold value. The online system 140 may vary the number of distances weighted by their corresponding temporal decay factors selected for the set based on different criteria in some embodiments.

In various embodiments, the online system 140 identifies a subset of the retrieved characteristics associated with prior presentation of the content item, or of other content items, to other users 340 and determines the measure of dissimilarity based on differences between characteristics in the subset of and characteristics of the opportunity to present the content item to the viewing user. For example, the online system 140 generates clusters of characteristics associated with prior presentations of the content item, or of other content items, to users of the online system 140 using one or more clustering methods. For example, the online system 140 identifies clusters of characteristics of users through a k-means clustering algorithm using Euclidean distance mean or cosine distance between characteristics of presentations of the content item or of other content items. As another example, the online system 140 identifies a subset of characteristics based on classification of characteristics of presentation of the content item or of other content items to users by one or more non-linear classification methods. For example, the online system 140 applies a gradient boosted decision tree (GBDT) method to characteristics of prior presentation of the content item or of other content items to users. Application of the one or more non-linear classification methods to characteristics of presentation of the content item or of other content items generates clusters of characteristics associated with prior presentation of the content item or of other content items. The online system 140 identifies a subset of characteristics associated with prior presentation of the content item or of other content items as a cluster of characteristics that is more frequently associated with prior presentations of the content item or of other content items to other users. Hence, the online system 140 may determine the measure of dissimilarity based on characteristics of users, characteristics of presentation of the content item or of other content items, or a combination of characteristics of users and characteristics of presentation of the content item. By accounting for characteristics of presentation of the content item (or of other content items) to various users and characteristics of the opportunity to present the content item to the viewing user, the online system 140 determines 340 a measure of dissimilarity that accounts for variations in how the content item is presented to the viewing user relative to prior presentation of the content item, or of other content items, to other users.

Based on the determined measure of dissimilarity and a model determining likelihood of the viewing user performing one or more interactions with the content item, the online system 140 determines 345 whether to present the content item to the viewing user. In various embodiments, the online system 140 modifies one or more attributes of the content item based on the measure of dissimilarity and uses the modified one or more attributes an one or more models determining likelihoods of the viewing user performing one or more interactions when the content item is presented (e.g., interactions with the content item). In various embodiments, the content item includes a bid amount specifying an amount of compensation a publishing user providing the content item to the online system 140 will provide the online system 140 in exchange for presentation of the content item to users or in exchange for one or more interactions with the content item by users. The online system 140 modifies the bid amount included in the content item based on the determined measure of dissimilarity. For example, the online system 140 increases the bid amount by an amount based on the determined measure of dissimilarity and includes the increased bid amount and one or models determining likelihoods of the viewing user performing one or more interactions when presented with the content item. The online system 140 may add the amount based on the determined measure of dissimilarity to the bid amount included in the content item. In various embodiments, the amount by which the bid amount is modified is directly related to the measure of dissimilarity, so the bid amount is modified by a larger amount as the measure of dissimilarity increases. For example, the online system 140 scales a value by a factor that is directly proportional to the measure of dissimilarity and adds the scaled value to the bid amount included in the content item to modify the bid amount of the content item. The amount by which the bid amount is modified may have a maximum and a minimum value in various embodiments. In the preceding example, the factor that is directly proportional to the measure of dissimilarity ranges from 0 to 1, so the bid amount included in the content item is modified by an amount ranging from 0 to the value. In other embodiments, the online system 140 may modify a measure of relevance of the content item to the viewing user based on the determined measure of dissimilarity as described above.

In various embodiments, to determine 345 whether to present the content item to the viewing user, the online system 140 includes the content item in association with the modified one or more attributes and the one or more models in one or more selection processes that include additional content items eligible for presentation to the viewing user. Content items selected by the one or more selection processes are provided by the online system 140 to a client device 110 for presentation to the viewing user. As described above in conjunction with FIGS. 2, a selection process may rank the content item and the additional content items based on bid amounts included in the content item and in the additional content item and select content items having at least a threshold position in the ranking for presentation to the viewing user. As another example, a selection process selects content items from the content item and the additional content items having at least a threshold bid amount for presentation to the viewing user. Increasing the bid amount included in the content item by an amount based on the determined measure of dissimilarity thus increases a likelihood of the one or more selection processes selecting the content item for presentation to the viewing user. As the amount by which bid amount included in the content item increases as the determined measure of dissimilarity increases, the one or more selection processes are more likely to select the content item for presentation when characteristics of the viewing user are more different from characteristics of the one or more users to whom the content item was presented (or of the users for whom the online system 140 retrieved 325 characteristics as described above).

Similarly, one or more selection processes may select content items from the content item and the additional content items for presentation to the viewing user based on measures of relevance of the content item and of the additional content items to the viewing user, as further described above in conjunction with FIG. 2. For example, a selection process ranks the content item and the additional content items based on their measures of relevance to the viewing user and selects content items having a threshold position in the ranking for presentation to the viewing user. If the measure of relevance of the content item to the user is increased based on the determined measure of difference, the selection process in the preceding example is more likely to select the content item for presentation when the viewing user has characteristics that are dissimilar to characteristics of other users to whom the content item was presented.

By modifying an attribute of the content item based on the measure of dissimilarity between the viewing user and other users to whom the content item was presented and using the modified attribute and the one or more models determining likelihoods of the user performing one or more interactions when presented with the content item to determine 345 whether the content item is presented to the viewing user, the online system 140 presents the content item to users having a broader range of characteristics. This allows the publishing user who provided the content item to the online system 140 to evaluate how users having a broader range of characteristics interact with the content item, which may allow the publishing user to provide more relevant content to more users. In various embodiments, the online system 140 provides the publishing users with information describing modification of the attribute of the content item on presentation of the content item by the online system 140.

In response to determining 345 to present the content item to the viewing user, the online system 140 provides 350 the content item to a client device 110 associated with the viewing user for presentation to the viewing user. When the client device 110 presents the content item to the viewing user, the online system 140 receives 355 information from the client device indicating whether the user performed one or more interactions after being presented with the content item. For example, an application associated with the online system 140 and executing on the client device 110 transmits information to the online system 140 identifying one or more interactions with the content item by the viewing user or identifying one or more actions performed by the viewing user after presentation of the content item. Based on the received information and the characteristics of the viewing user, the online system 140 modifies 360 one or more models determining the likelihood of the viewing user performing one or more interactions after being presented with the content item. For example, if the received information indicates the viewing user performed an interaction with the content item, the online system 140 modifies 360 a model determining a likelihood of users performing the interaction with the content item so the model determines a higher likelihood of users having one or more characteristics of the viewing user performing the action. Similarly, if the received information indicates the viewing user did not perform the interaction with the content item or if the online system 140 does not receive information indicating the user performed the interaction with the content item at least a threshold amount of time after the content item was presented to the viewing user, the online system 140 modifies 360 the model determining a likelihood of users performing the interaction with the content item so the model determines a lower likelihood of users having one or more characteristics of the viewing user performing the action. In various embodiments, the online system 140 determines a rate of change of a model that is modified based on interactions by viewing users presented with content items based at least in part on measures of dissimilarity between the viewing users and other users previously presented with the content item and ceases determining whether to present the content item to viewing users based on the measures of dissimilarity if a rate of change of the model does not exceed a threshold rate of change.

In some embodiments, the online system 140 modifies determination of the measure of dissimilarity between the viewing user and the one or more users to whom the content item was presented (or one or more users identified as further described above) over time to increase a likelihood that modifying the attribute of the content item based on the determined measure of dissimilarity causes the online system 140 to determine 345 to present the content item to viewing users having different characteristics than characteristics of the one or more users to whom the content item was presented (or of the one or more users identified as further described above). For example, the online system 140 retrieves information describing previously completed selection processes for one or more other content items, modifies the attribute of the one or more content items included in a previously completed selection process, and compares the modified attribute of the one or more content items to values of the attributes for additional content items in the previously completed selection processes. Comparison of the modified attributes to attributes in the previously completed selection processes allows evaluation of the effectiveness of the modified attributes in selection of the one or more content items by selection processes by identifying previously completed selection processes in which the modified attributes would have caused selection of the one or more content items.

In one embodiment, the online system 140 determines a total amount of the modified attribute of the content item as the online system 140 modifies an attribute of the content item when determining 345 whether to present the content item for opportunities to present one or more content items to users. For example, if the bid amount included in the content item is modified based on the measure of dissimilarity, the online system 140 determines a sum of modified bid amounts associated with the content item when the content item is included in one or more selection processes. As another example, if the bid amount included in the content item is modified based on the measure of dissimilarity, the online system 140 determines a difference between the bid amount included in the content item without modification.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving content items at an online system for presentation to users of the online system;
maintaining one or more characteristics associated with each user of the online system;
presenting a content item of the received content items to one or more users of the online system;
identifying an opportunity to present one or more content items to a viewing user;
determining the content item is eligible for presentation to the viewing user;
retrieving characteristics associated with the viewing user that is maintained by the online system;
retrieving characteristics associated with one or more users of the online system to whom the content item was presented;
determining a measure of dissimilarity between the viewing users and the one or more users of the online system to whom the content item was presented based on differences between characteristics associated with the viewing user that are maintained by the online system and characteristics associated with the one or more users of the online system to whom the content item was presented;
determining to present the content item to the viewing user based on the determined measure of dissimilarity and a model determining a likelihood of the viewing user interacting with the content item;
providing the content item to a client device for presentation to the viewing user;
receiving information from the client device indicating whether the viewing user interacted with the content item; and
modifying the model determining the likelihood of the viewing user interacting with the content item based on the received information from the client device indicating whether the viewing user interacted with the content item and the characteristics of the viewing user.

2. The method of claim 1, wherein determining to present the content item to the viewing user based on the determined measure of dissimilarity and the model determining the likelihood of the viewing user interacting with the content item comprises:
increasing a bid amount of the content item specifying an amount of compensation received by the online system in exchange for presenting the content item based on the determined measure of dissimilarity; and
including the increased bid amount and model determining a likelihood of the viewing user interacting with the content item in one or more selection processes selecting content for presentation to the viewing user.

3. The method of claim 2, wherein increasing the bid amount of the content item specifying an amount of compensation received by the online system in exchange for presenting the content item based on the determined measure of dissimilarity comprises:
increasing the bid amount of the content item by an amount determined based on the determined measure of dissimilarity.

4. The method of claim 3, wherein increasing the bid amount of the content item by an amount determined based on the determined measure of dissimilarity comprises:
adding the value determined based on the determined measure of dissimilarity to the bid amount of the content item.

5. The method of claim 4, wherein the amount is directly related to the determined measure of dissimilarity.

6. The method of claim 1, determining the measure of dissimilarity between the viewing user and the one or more users of the online system to whom the content item was presented comprises:
generating a vector for the viewing user having dimensions based on characteristics of the viewing user;
generating a vector for each of the one or more users of the online system to whom the content item was presented based on having dimensions based on characteristics associated with one or more users of the online system to whom the content item was presented; and
determining the measure of dissimilarity based on distances between the vector for the viewing user and one or more of the vectors for the one or more users of the online system to whom the content item was presented.

7. The method of claim 1, wherein determining the measure of dissimilarity between the viewing user and the one or more users of the online system to whom the content item was presented comprises:
identifying a subset of characteristics of the one or more users to whom the content item was presented; and
determining the measure of dissimilarity based on differences between characteristics associated with the viewing user that are included in the subset and characteristics associated with the one or more users of the online system to whom the content item was presented that are included in the subset.

8. The method of claim 7, wherein identifying the subset of characteristics of the one or more users to whom the content item was presented comprises:
generating clusters of characteristics of users of the online system; and
identifying the subset of characteristics of the one or more users to whom the content item as characteristics included in a cluster of characteristics that is more frequently associated with users to whom the content item was presented than to general users of the online system.

9. The method of claim 8, wherein identifying the subset of characteristics of the one or more users to whom the content item was presented comprises:
determining characteristics of users indicating a likelihood of users interacting with content from prior selection of content for presentation to one or more users.

10. The method of claim 1, wherein determining the measure of dissimilarity between the viewing users and the one or more users of the online system to whom the content item was presented comprises:
determining characteristics of sets of users, each set including users to whom the content item was presented at different times;
determining differences between characteristics of the user and characteristics of different sets of users;
weighting each difference by a temporal decay factor corresponding to a time when the content item was presented to users in a set used to determine a difference;
selecting a set of the weighted differences; and
determining the measure of dissimilarity as an average of the selected set of weighted differences.

11. A computer program product comprising a computer readable storage medium having instructions encoded thereon that, when executed by a processor, cause the processor to:
receive content items at an online system for presentation to users of the online system;
maintain one or more characteristics associated with each user of the online system;
present a content item of the received content items to one or more users of the online system;
identify an opportunity to present one or more content items to a viewing user;
determine the content item is eligible for presentation to the viewing user;
retrieve characteristics associated with the viewing user that are maintained by the online system;
retrieve characteristics associated with one or more users of the online system to whom the content item was presented;
determine a measure of dissimilarity between the viewing users and the one or more users of the online system to whom the content item was presented based on differences between characteristics associated with the viewing user that are maintained by the online system and characteristics associated with the one or more users of the online system to whom the content item was presented;
determine to present the content item to the viewing user based on the determined measure of dissimilarity and a model determining a likelihood of the viewing user interacting with the content item;
provide the content item to a client device for presentation to the viewing user;
receive information from the client device indicating whether the viewing user interacted with the content item; and
modify the model determining the likelihood of the viewing user interacting with the content item based on the received information from the client device indicating whether the viewing user interacted with the content item and the characteristics of the viewing user.

12. The computer program product of claim 11, wherein determine to present the content item to the viewing user based on the determined measure of dissimilarity and the model determining the likelihood of the viewing user interacting with the content item comprises:
increase a bid amount of the content item specifying an amount of compensation received by the online system in exchange for presenting the content item based on the determined measure of dissimilarity; and
include the increased bid amount and model determining a likelihood of the viewing user interacting with the content item in one or more selection processes selecting content for presentation to the viewing user.

13. The computer program product of claim 12, wherein increase the bid amount of the content item specifying an amount of compensation received by the online system in exchange for presenting the content item based on the determined measure of dissimilarity comprises:
increase the bid amount of the content item by an amount determined based on the determined measure of dissimilarity.

14. The computer program product of claim 13, wherein increase the bid amount of the content item by an amount determined based on the determined measure of dissimilarity comprises:
add the value determined based on the determined measure of dissimilarity to the bid amount of the content item.

15. The computer program product of claim 13, wherein the amount is directly related to the determined measure of dissimilarity.

16. The computer program product of claim 11, determine the measure of dissimilarity between the viewing user and the one or more users of the online system to whom the content item was presented comprises:
generate a vector for the viewing user having dimensions based on characteristics of the viewing user;
generate a vector for each of the one or more users of the online system to whom the content item was presented based on having dimensions based on characteristics associated with one or more users of the online system to whom the content item was presented; and
determine the measure of dissimilarity based on distances between the vector for the viewing user and one or more of the vectors for the one or more users of the online system to whom the content item was presented.

17. The computer program product of claim 11, wherein determine the measure of dissimilarity between the viewing user and the one or more users of the online system to whom the content item was presented comprises:
identify a subset of characteristics of the one or more users to whom the content item was presented; and
determine the measure of dissimilarity based on differences between characteristics associated with the viewing user that are included in the subset and characteristics associated with the one or more users of the online system to whom the content item was presented that are included in the subset.

18. The computer program product of claim 17, wherein identify the subset of characteristics of the one or more users to whom the content item was presented comprises:
generate clusters of characteristics of users of the online system; and
identify the subset of characteristics of the one or more users to whom the content item as characteristics included in a cluster of characteristics that is more frequently associated with users to whom the content item was presented than to general users of the online system.

19. The computer program product of claim 18, wherein identify the subset of characteristics of the one or more users to whom the content item was presented comprises:
determine characteristics of users indicating a likelihood of users interacting with content from prior selection of content for presentation to one or more users.

20. The computer program product of claim 11, wherein determine the measure of dissimilarity between the viewing users and the one or more users of the online system to whom the content item was presented comprises:
determine characteristics of sets of users, each set including users to whom the content item was presented at different times;
determine differences between characteristics of the user and characteristics of different sets of users;
weight each difference by a temporal decay factor corresponding to a time when the content item was presented to users in a set used to determine a difference;
select a set of the weighted differences; and
determine the measure of dissimilarity as an average of the selected set of weighted differences.
